(19) United States
(12) Patent Application Publication
(10) Pub. No.: US 2008/0055268 A1
(43) Pub. Date: Mar. 6, 2008

(54) TOUCH SCREEN PANEL AND METHOD FOR MANUFACTURING THE SAME

(76) Inventors: Dan-Sik YOO, Gyeonggi-do (KR); Teruo KATAKURA, Gyeonggi-do (KR); Chang-Wook KANG, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/847,825

(22) Filed: Aug. 30, 2007

(30) Foreign Application Priority Data
Sep. 1, 2006 (KR) 2006-83960
Feb. 27, 2007 (KR) 2007-19564

(51) Int. Cl. G06F 3/041; G09G 3/36

(52) U.S. Cl. 345/173; 345/92

(57) ABSTRACT

A plurality of pixel parts is electrically connected to gate and source lines. Each of the pixel parts has a thin-film transistor (TFT) formed therein. A plurality of hall sensing parts is formed in the pixel parts. A plurality of hall sensing parts varies a reference current applied to the gate and the source lines by a magnetic member. The position detector is electrically connected to the gate lines and the source lines. The position detector detects a position of the magnetic member using the gate and source lines to which a varied current is applied. The plurality of hall sensing parts formed in the pixel parts detect the position of the magnetic member that approaches or contacts the screen of the display.

### CROSS-REFERENCE TO RELATED APPLICATIONS

This application claims priority under 35 U.S.C. § 119 to Korean Patent Application No. 2006-83960 filed on Sep. 1, 2006 and Korean Patent Application No. 2007-19564 filed on Feb. 27, 2007 in the Korean Intellectual Property Office (KIPO), the contents of which are herein incorporated by reference in their entireties.

### BACKGROUND OF THE INVENTION

1. Field of the Invention

The present invention relates to a touch screen panel and, more particularly, to a touch screen panel used for a display device and a method for manufacturing the touch screen panel.

2. Description of the Related Art

Generally, a liquid crystal display (LCD) device includes an LCD panel including a display substrate having a plurality of thin-film transistors (TFTs) formed in a matrix shape to display an image, an opposing substrate facing the display substrate and a liquid crystal layer interposed between the display substrate and the opposing substrate.

An LCD device equipped with a touch screen pad allows a user to directly input data by touching the screen displaying an image. The touch screen pad detects the input position and provides a result indicating the detected position allowing the associated electronics to update the display in accordance with the detected position.

However, the cost of the touch screen pad is high and, and increases the thickness of the LCD device as well as reducing the luminance of the display. Furthermore, in order to form the touch screen pad in the LCD device, additional processing steps are required.

### SUMMARY OF THE INVENTION

The present invention provides a touch screen panel having decreased manufacturing cost, thickness and manufacturing process steps.

In one aspect of the present invention, a touch screen panel includes a plurality of pixel parts, a plurality of hall sensing parts and a position detector. Each of the pixel parts is electrically connected to one of a plurality of gate lines and one of a plurality of source lines. The hall sensing parts are formed in the pixel parts. The hall sensing parts vary a reference current applied to the gate lines and the source lines by a magnetic member. The position detector is electrically connected to the gate lines and the source lines and detects the position of the magnetic member using the gate and source lines to which the varied reference current is applied.

In an exemplary embodiment, each of the pixel parts includes a thin-film transistor (TFT) electrically connected to one of the gate lines and one of the source lines. The hall sensing parts are formed in areas different from the TFT at edge portions at which the gate lines and the source lines cross each other. The hall sensing parts and the TFT are formed from the same layer.

Each of the hall sensing parts may include a first hall sensor electrically connected to one of the gate lines, and a second hall sensor electrically connected to one of the source lines. The first hall sensor may include a first silicon layer, first and second electrodes and third and fourth electrodes. The first silicon layer is formed on the gate lines. The first and second electrodes are formed in two end portions of the first silicon layer, which are substantially parallel with the gate lines. The first and second electrodes are electrically connected to the gate lines. The third and fourth electrodes are formed in two end portions of the first silicon layer, which are substantially perpendicular to the gate lines. The third and fourth electrodes are electrically connected to the first and second electrodes, respectively.

The third and fourth electrodes apply an additional current that is generated by the magnetic member to the gate lines through the first and second electrodes to vary the reference current.

The second hall sensor may include a second silicon layer, fifth and sixth electrodes, and seventh and eighth electrodes. The second silicon layer is formed on the source lines. The fifth and sixth electrodes are formed in two end portions of the second silicon layers, which are substantially parallel with the source lines. The fifth and sixth electrodes are electrically connected to the source lines. The seventh and eighth electrodes are formed in two end portions of the second silicon layer, which are substantially perpendicular to the gate lines. The seventh and eighth electrodes are electrically connected to the fifth and sixth electrodes, respectively.

The seventh and eighth electrodes apply an additional current that is generated by the magnetic member to the source lines through the fifth and sixth electrodes to vary the reference current.

In an exemplary embodiment, the touch screen panel may further include a gate driving section and a source driving section. The gate driving section is disposed at a first side of the insulation substrate. The gate driving section applies a gate voltage from the first side to a second side facing the first side. The source driving section is disposed at a third side perpendicular to the first and second sides. The source driving section applies a source voltage from the third side to a fourth side facing the third side.

The position detector may be integrated in the source driving section. The position detector may be electrically connected to a first detecting line part that connects end portions of the gate lines in correspondence to the second side, and a second detector that connects end portions of the source lines in correspondence to the fourth side. Here, the first detecting line part includes a plurality of first detecting lines connected to each of the gate lines, and a plurality of second detecting lines connected to each of the source lines.

The source driving section repeatedly supplies a source start voltage and the source voltage to the source lines. The reference current may be synchronized to the source start voltage and applied to the gate and source lines.

In an exemplary embodiment, the touch screen panel may further include a power supplying section. The power supplying section is electrically connected to the gate driving section and the source driving section to supply the gate voltage and the source voltage to the gate driving section and the source driving section, respectively. Here, the reference current may be applied from the gate driving section, the source driving section and the power supplying section.

In an exemplary embodiment, the insulation substrate may include a display area having the gate and source lines formed thereon and a peripheral area adjacent to the display area, wherein the position detector is formed on the peripheral area.

In another aspect of the present invention, in order to manufacture a touch screen panel, a gate line and a source line are formed on an insulation substrate, and a gate electrode is formed on a TFT area. Then, a first insulation layer is formed on the gate electrode, the gate line and the source line. Then, a silicon layer is formed on the TFT silicon area of the gate electrode, and a silicon layer is formed on a hall sensing part area of the gate and source lines. Then, a source electrode and a drain electrode are formed on the TFT silicon layer, and a plurality of electrodes is formed on the silicon layer.

Here, the number of the electrodes is four in correspondence to the gate line, and the number of the electrodes is four in correspondence to the source lines.

In an exemplary embodiment, a second insulation layer is formed on the source electrode, the drain electrode and the electrodes. Then, a pixel electrode electrically connected to the drain electrode is formed on the second insulation layer corresponding to a pixel part.

According to the touch screen panel and the method for manufacturing the touch screen panel, a plurality of hall sensing parts is formed in pixel parts to detect a position of a magnetic member that approaches or is contacted to the touch screen panel from the exterior, so that the conventional touch screen pad may be omitted. Therefore, manufacturing costs, thickness and the number of manufacturing processes of the touch screen panel may be reduced.

### BRIEF DESCRIPTION OF THE DRAWINGS

The above and other advantages of the present invention will become readily apparent by reference to the following detailed description when considered in conjunction with the accompanying drawings, in which:

FIG. 1 is a side view illustrating a touch screen panel according to an exemplary embodiment of the present invention;

FIG. 2 is a plan view illustrating the display substrate in FIG. 1;

FIG. 3 is a partially enlarged plan view illustrating a pixel part in FIG. 2;

FIG. 4 is a plan view illustrating the thin-film transistor (TFT) and a hall sensing part of FIG. 3;

FIG. 5 is a cross-sectional view taken along a line I-I′ of FIG. 4;

FIG. 6 is a graph showing an reference current applied to the gate lines and the source lines in FIG. 2;

FIG. 7 is a waveform diagram showing a timing of an reference current that is applied to a display substrate in FIG. 2; and

FIGS. 8A to 8D are cross-sectional views illustrating a manufacturing process of a display panel for a touch screen according to an exemplary embodiment of the present invention.

### DESCRIPTION OF THE EMBODIMENTS

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

Hereinafter, the present invention will be described in detail with reference to the accompanying drawings.

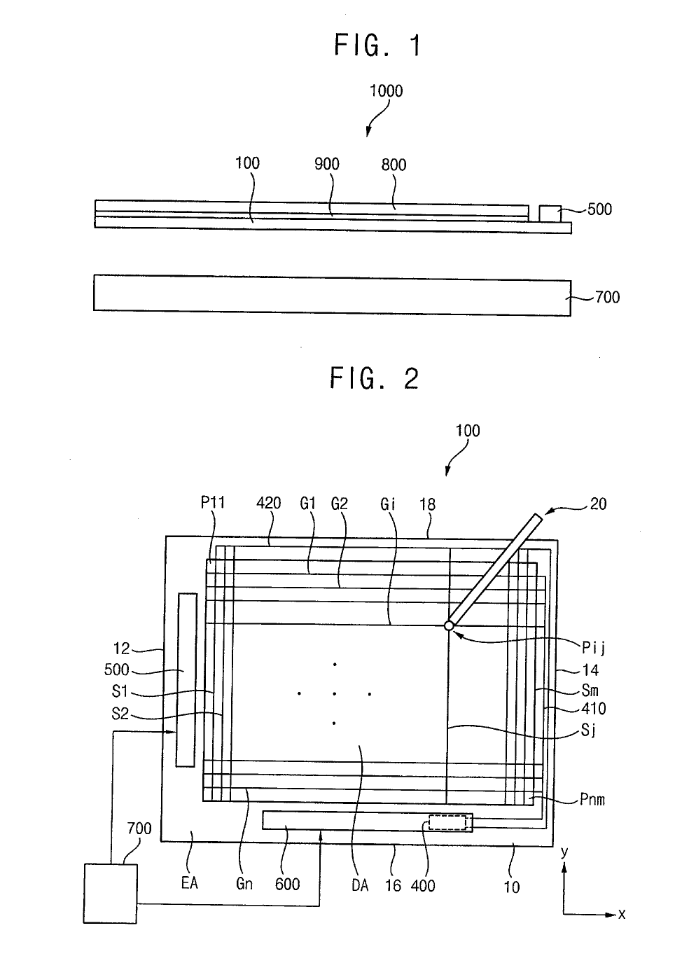

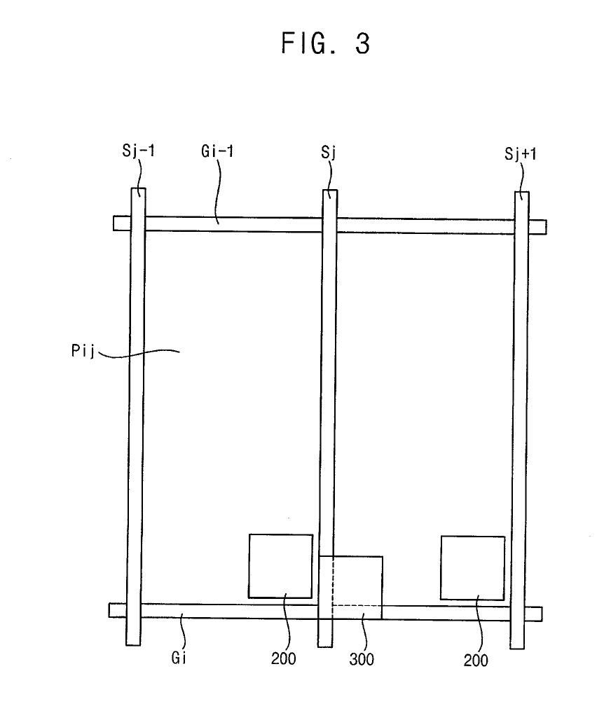

FIG. 1 is a side view illustrating a touch screen panel according to an exemplary embodiment of the present invention. FIG. 2 is a plan view illustrating the display substrate in FIG. 1. FIG. 3 is a partially enlarged plan view illustrating a pixel part in FIG. 2.

Referring to FIGS. 1 to 4, a touch screen panel 1000 according to an exemplary embodiment of the present invention includes a display substrate 100 and an opposing substrate 800.

The display substrate 100 includes a plurality of gate lines G1 to Gn, a plurality of source lines S1 to Sm, a plurality of hall sensing parts 300 and a position detector 400. Here, ‘n’ and ‘m’ are natural numbers.

The gate lines G1 to Gn are formed on an insulation substrate 10 in parallel with a first axis (i.e., x-axis). For example, the gate lines G1 to Gn may be formed on the insulation substrate from a first side portion 12 of the insulation substrate 10 to a second side portion 14 of the insulation substrate 10, which faces the first side portion 12 thereof. The insulation substrate 10 includes a display area DA having a plurality of gate lines G1 to Gn to display an image, and a peripheral area EA surrounding the display area DA.

The source lines S1 to Sm cross the gate lines G1 to Gn to be formed in the display area DA. For example, the source lines S1 to Sm may be formed in parallel with each other along a second axis ‘y’ crossing the first axis ‘x’, which along a direction perpendicular to the gate lines G1 to Gn. Particularly, the source lines S1 to Sm are formed from a third side portion 16 perpendicular to the first and second side portions 12 and 14 to a fourth side portion 18 opposite to the third side portion 16. Alternatively, the source lines S1 to Sm and the gate lines G1 to Gn may be formed in a substantially acute angle.

The source lines S1 to Sm are formed upon the gate lines G1 to Gn to be electrically insulated from the gate lines G1 to Gn. Alternatively, the source lines S1 to Sm may be formed below the gate lines G1 to Gn to be electrically insulated from the gate lines G1 to Gn.

In one exemplary embodiment, the gate lines G1 to Gn and the source lines S1 to Sm define the plurality of pixel parts P11 to Pnm on the insulation substrate 10; however, the pixel parts P11 to Pnm may also be otherwise defined. A plurality of thin-film transistors (TFTs) 200 is formed at corners that cross the gate lines G1 to Gn and the source lines S1 to Sm in the pixel parts P11 to Pnm. The TFT 200 may be electrically connected to the gate line G1 and the source line Sj+1. The TFT 200 may include silicon (Si) that is a semiconductor material. The TFT 200 may be formed by the same method as that of a conventional semiconductor manufacturing process. A detailed description for the above will be described later.

The hall sensing parts 300 are formed in the pixel parts P11 to Pnm. For example, the hall sensing part 300 may be formed at an edge portion crossing the gate line G1 and the source line Sj+1. Here, the hall sensing part 300 is not overlapped with the TFT 200 to be formed at a different edge portion from the TFT 200.

The hall sensing parts 300 may be disposed in one-to-one correspondence with the pixel parts P11 to Pnm. Alternatively, the hall sensing part 300 may be disposed in a predetermined number of pixel parts P11 to Pnm in accordance with a type of a magnetic member 20 or needed sensitivity on the touch screen panel. The hall sensing part 300 is electrically connected to the gate line Gn and the source line Sm, similarly to the TFT 200.

The hall sensing part 300 induces a current through a magnetic force by a formation of a magnetic field, or varies the reference current IR to be detected as a detecting current ID. The hall sensing part 300 may be formed based on silicon, similarly to the TFT 200.

When a magnetic member 20 is approached or contacted to the display substrate 100 having the hall sensing parts 300 formed thereon, the hall sensing parts 300 may vary a current in response to a magnetic field generated by the magnetic member 20. For example, the hall sensing parts 300 may vary the current that is applied to the gate and source lines G1 and Sj adjacent to the magnetic member 20. Here, ‘i’ and ‘j’ are natural numbers.

A variation of the reference current IR is detected by a position detector 400 electrically connected to the gate lines G1 to Gn and the source lines S1 to Sm. The position detector 400 may be integrated in the source driving part 600 electrically connected to the source lines S1 to Sm. Alternatively, the position detector 400 may be formed in a peripheral area EA of the insulation substrate 10. Alternatively, the position detector 400 may be formed on a control part (not shown) of an electrical device (not shown) having the display panel 1000 of the present invention mounted thereon.

The position detector 400 may be electrically connected to a first detection line part 410 and a second detection line part 420, respectively. The first detection line part 410 electrically connects end terminals of the gate lines G1 to Gn corresponding to a second side portion 14. The second detection line part 420 electrically connects end terminals of the source lines S1 to Sm corresponding to a fourth side portion 18.

For example, as the reference current is varied by a detection of the magnetic member 20 of the hall sensing part 300 of the gate lines G1 to Gn and the source lines S1 to Sm formed along first and second axes x and y, the position detector 400 may detect an approaching or a contacting position of the magnetic member 20 through a pixel part Pij defined by the gate line Gi and the source line Sj, and the first and second detecting line parts 410 and 420.

For example, when each of the first and second detecting line parts 410 and 420 includes a plurality of first detecting lines and a plurality of second detecting line that are electrically connected to the gate lines G1 to Gn and the source lines S1 to Sm, respectively, the position detector 400 may directly detect a position of the magnetic member 20 using the first and second detecting lines. Alternatively, when the first and second detecting line parts 410 and 420 are electrically connected to the gate lines G1 to Gn and the source lines S1 to Sm, the position detector 400 may include a position analysis part (not shown) analyzing a position through an reference current IR to indirectly detect a position of the magnetic member 20.

Data detected by the position detector 400 is applied to a control part (not shown) of an electric device (not shown) having the display panel 1000 mounted thereon to be processed following operations. For example, the control part (not shown) may display an additional image, or may provide a different electric device (not shown) with the data.

Accordingly, when the magnetic member 20 is approached or contacted to the display panel 1000 having the hall sensing parts 300 formed thereon, the hall sensing part 300 corresponding to the approached or contacted portion varies a reference current IR applied to the gate line Gi and the source line Sj of the pixel part Pij, so that the position detector 400 may easily detect a position of the magnetic member 20.

The display panel 1000 may further include a gate driving section 500 and a source driving section 600 formed in the peripheral area EA of the insulation substrate 10. The gate driving section 500 is disposed in the first side portion 12 of the insulation substrate 10 to provide a gate voltage from the first side portion 12 to the second side portion 14 facing the first side portion 12.

The source driving section 600 may be disposed in a third side portion 16 substantially perpendicular to the first and second side portions 12 and 14 to provide a source voltage from the third side portion 16 to a fourth side portion 18 facing the third side portion 16. For example, each the gate and source driving sections 500 and 600 may include a drive chip type, respectively.

The position detector 400 may be formed into the source driving section 600, as described above. Here, an additional drive chip for detecting a position of the magnetic member 20 approached or contacted to a surface of the display substrate 100 is not required, so that manufacturing costs of the touch screen panel may be decreased. Furthermore, the number of manufacturing process may be decreased. Alternatively, when the position detector 400 is not directly integrated on the source driving section 600 due to a processing capacitance thereof, the position detector 400 may be mounted in a peripheral area EA of the insulation substrate 10 in a driver chip type for detecting the position.

The display panel 1000 may further include a power supplying section 700 electrically connected to the gate driving section 500 and the source driving section 600 to supply a gate voltage and a source voltage to the gate driving section 500 and the source driving section 600, respectively.

The opposite substrate 800 is disposed to face the display substrate 100. A liquid crystal layer 900 is interposed between the opposite substrate 800 and the display substrate 100. The opposite substrate 800 is a color filter substrate having a common electrode of a transparent material formed therein and RGB pixels formed therein. When electric field is applied to the liquid crystal layer 900, an arrangement of liquid crystal molecules of the liquid crystal layer 900 is altered to change optical transmissivity, so that images are displayed on the display panel 1000.

An additional backlight assembly may be disposed below the display panel 1000, which provides light to the display panel 1000. Alternatively, the display panel 1000 may include an organic light layer capable of emitting light, so that the display panel 1000 may be used as a display device. Alternatively, the display panel 1000 may be used as a display device by including an organic light layer capable of emitting light instead of the liquid crystal layer 900.

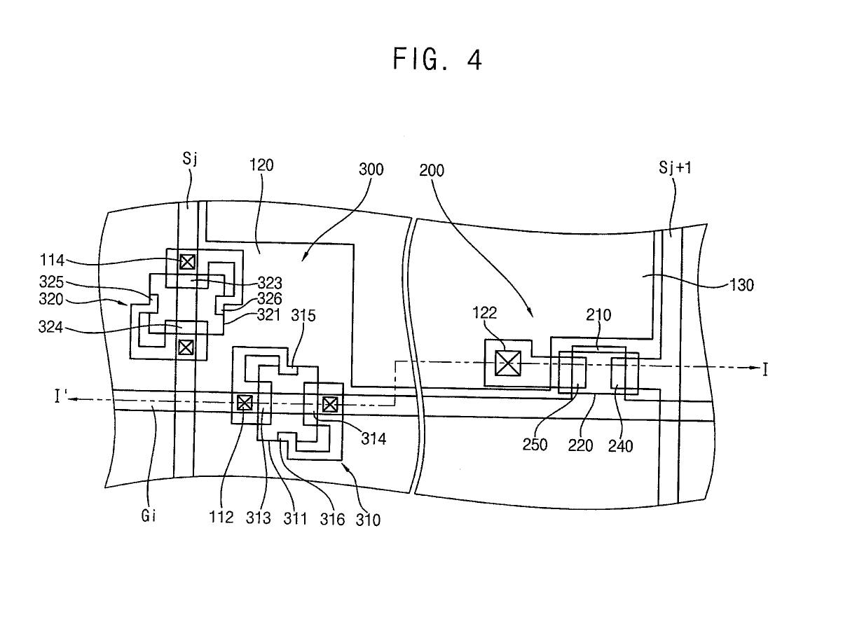

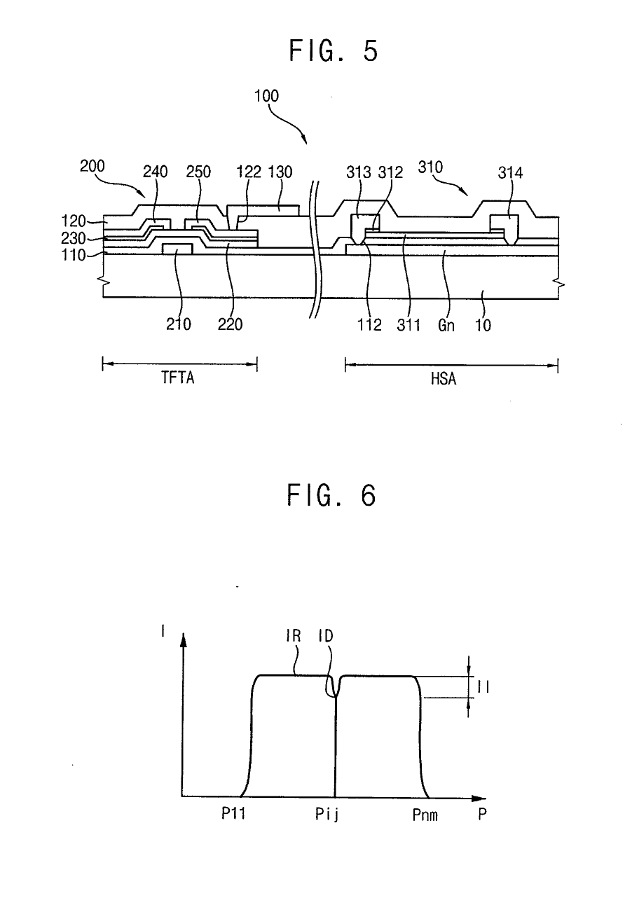

FIG. 4 is a plan view illustrating the TFT and a hall sensing part of FIG. 3. FIG. 5 is a cross-sectional view taken along a line I-I′ of FIG. 4. FIG. 6 is a graph showing a reference current IR applied to the gate lines and the source lines in FIG. 2.

Referring to FIGS. 2, 4 to 6, the hall sensing part 300 includes a first hall sensor 310 and a second hall sensor 320.

The first hall sensor 310 is electrically connected to the gate line Gn. The first hall sensor 310 includes a first silicon layer 311, and first, second, third and fourth electrodes 313, 314, 315 and 316.

The first silicon layer 311 may include a gate line Gn. The first silicon layer 311 may substantially define a hall sensing part area HSA. A TFT silicon layer 220 is formed in the pixel part Pnm. The TFT silicon layer 220 may define a TFT area TFTA.

The first, second, third and fourth electrodes 313, 314, 315 and 316 are formed on the first silicon layer with substantially the same inner angle. For example, the inner angles between the first, second, third and fourth electrodes 313, 314, 315 and 316 may be about 90 degrees. A source electrode 240 electrically connected to the source line Sj and a drain electrode 250 electrically connected to the pixel electrode 130 are formed in a TFT area TFTA. The pixel electrode 130 is substantially fully formed in the pixel part Pij.

Accordingly, the hall sensing part 300 may be formed from a forming process of a conventional TFT 200 except additional process. Therefore, an increasing of the number of manufacturing process may be prevented, which may be generated due to the hall sensing part 300.

The first and second electrodes 313 and 314 are formed in two end portions parallel with the gate line Gn of the first silicon layer 311. The first and second electrodes 313 and 314 are electrically connected to the gate line Gn.

The display substrate 100 may further include a first insulation layer 110 formed on the gate line Gi and the source line Sj. Here, a first electrode contact hole 112 may be formed in the first insulation layer 110. The first electrode contact hole 112 electrically connects to the first and second electrodes 313 and 314 and the gate line Gn.

The third and fourth electrodes 315 and 316 are formed in two end portions perpendicular to the gate line Gn of the first silicon layer 311. The third and fourth electrodes 315 and 316 are electrically connected to the gate line Gn similar to the first and second electrodes 313 and 314. The third electrode 315 may be electrically connected to the first electrode 313, and the fourth electrode 316 may be electrically connected to the second electrode 314.

Hereinafter, a method of detecting a detecting current ID (i.e., the varied reference current IR) by the first hall sensor 310 will be described as follows. A reference current IR is applied to the gate line Gn and the source line Sm. Therefore, an induced current II is induced in the first and second electrodes 313 and 314 by the reference current IR delivered through the gate line Gn.

The induced current II transfers a plurality of predetermined electrons between the first and second electrodes 313 and 314. When the magnetic member 20 having a magnetic force is approached or contacted to a portion crossing a predetermined gate line Gi and a predetermined source line Sj formed on the display substrate 100, a magnetic field is formed in the pixel part Pij defined by the gate line Gi and the source line Sj by the magnetic member 20. Thus, the electrons are affected by the magnetic field, so that the electrons are affected by the Lorentz force formed along a direction perpendicular to a progress direction.

A predetermined electromotive force is generated in the third and fourth electrodes 315 and 316 perpendicular to the first and second electrodes 313 and 314, so that an induced current II is allowed to flow. The induced current II is again applied to the gate line Gi through the first and second electrodes 313 and 314 electrically connected to the third and fourth electrodes 315 and 316, respectively. As a result, the reference current IR may be varied by the induced current II that is additionally generated by the magnetic member 20. The varied reference current IR is outputted as the detecting current ID.

Hereinafter, a reference current IR varied by the magnetic member 20, that is the detecting current ID, will be described through FIG. 6. A uniform reference current IR is applied to the gate lines G1 to Gn and the source lines S1 to Sm. Thus, a reference current IR of a predetermined quantity is formed in the pixel parts P11 to Pnm.

When the magnetic member 20 is approached or contacted to the pixel part Pij, an induced current II is generated in the pixel part Pij so that a current quantity corresponding to the reference current IR is increased or decreased. When the reference current IR is increased, a polarity of the induced current II may be substantially the same as that of the reference current IR. On the other hand, when the reference current IR is decreased, a polarity of the induced current II may be different from that of the reference current IR.

The first hall sensor 310 may further include a first ohmic contact layer 312 formed therein, in order to decrease a resistance generated when the first silicon layer 311 and the first, second, third and fourth electrodes 313, 314, 315 and 316 are electrically contacted to each other. The TFT 200 may further include a TFT ohmic contact layer 230 that performs a role of the first ohmic contact layer 312 between the TFT silicon layer 220 and the source and drain electrodes 240 and 250.

The second hall sensor 320 is electrically connected to the source line Sm. The second hall sensor 320 includes a second silicon layer 321, and fifth, sixth, seventh and eighth electrodes 323, 324, 325 and 326. The second hall sensor 320 may further include a second hall ohmic contact layer substantially the same as the first hall ohmic contact layer 312 between the second hall silicon layer 311 and the fifth, sixth, seventh and eighth electrodes 323, 324, 325 and 326.

A second electrode contact hole 114 for electrically connecting to the fifth and sixth electrodes 323 and 324 may be formed in the first insulation layer 110. Here, the fifth and sixth electrodes 323 and 324 perform a function identical to that of the first and second electrodes 313 and 314 of the first hall sensor 310.

The second hall sensor 320 is substantially the same as the first hall sensor 320 except for the second hall sensor 320 is electrically connected to the source line Sm not the gate line Gn. Thus, any further explanation concerning the above elements will be omitted.

Therefore, the hall sensing part 300 includes the first hall sensor 310 that detects the varied reference current IR (i.e., the detecting current ID) from the gate line Gn and the second hall sensor 320 that detects the varied reference current IR (i.e., the detecting current ID) from the source line Sm based on an approach or a contact of the magnetic member 20, so that a position of the magnetic member 20 may be detected.

The display substrate 100 may further include a second insulation layer 120 formed on the source and drain electrodes 240 and 250 and the first, second, third, fourth, fifth, sixth, seventh and eighth electrodes 313, 314, 315, 316, 323, 324, 325 and 326, and a pixel electrode 130 formed on the second insulation layer 120. The pixel electrode 130 is formed in correspondence with the pixel part Pnm to be electrically connected to the drain electrode 250. Thus, a pixel electrode contact hole 122 may be formed in the second insulation layer 120 in order to electrically connect to the drain electrode 250 and the pixel electrode 130.

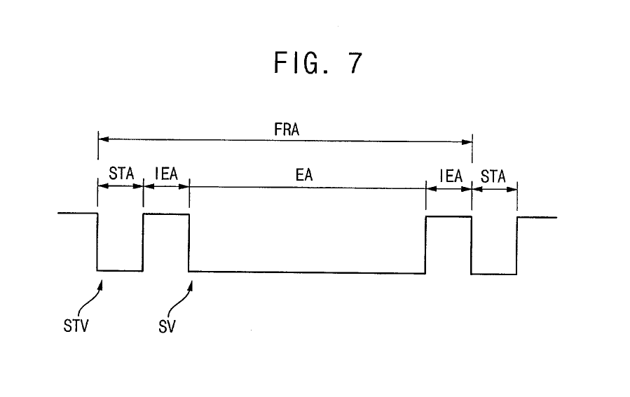

FIG. 7 is a waveform diagram showing timing of a reference current IR that is applied to a display substrate in FIG. 2.

Referring to FIGS. 2, 6 and 7, the source driving part 600 repeatedly applies a source start voltage STV and a source voltage SV to the source lines S1 to Sm of the display panel 1000.

During the source driving section 600 drives one frame interval FRA, the one frame FRA includes a start interval STA that corresponds to the source start voltage STV and an effective interval EA that corresponds to the source voltage SV.

The source start voltage STV may define a start timing of the source voltage SV. The source start voltage STV may define the number of the source lines S1 to Sm and a level of the source voltage SV before the source voltage SV is applied to the source lines S1 to Sm. The source driving section 600 may apply the different source start voltages STV to the source lines S1 to Sm in accordance with each of the frame intervals.

An ineffective interval IEA corresponding to a predetermined time difference is set between the start interval STA and the effective interval EA. During the ineffective interval IEA, substantially no signal is applied to the source lines S1 to Sm. For example, the ineffective interval IEA may be set to divide between the start interval STA and the effective interval EA.

The reference current IR is synchronized to the start interval STA corresponding to the source start voltage STV to be applied to the gate lines G1 to Gn and the source lines S1 to Sm. For example, the reference current IR may be synchronized to a rising time of the source start voltage STV. Alternatively, the reference current IR may be synchronized to a falling time of the source start voltage STV.

In one exemplary embodiment, the reference current IR may be additionally applied from the power supplying section 700 that provides the display panel 1000 with the source start voltage STV and the source voltage SV. In another exemplary embodiment, the reference current IR may be applied using the source start voltage STV provided from the power supplying section 700. In still another exemplary embodiment, the reference current IR may be applied from the gate driving section 500 and the source driving section 600.

Therefore, the position detection is performed in the start interval STA that is not interfered in the effective interval EA applying the source voltage SV so as to substantially display an image on the display panel 1000, so that the interference of an image displayed on the display substrate 100 may be prevented, which is generated by the magnetic member 20.

The reference current IR may be applied in the ineffective interval IEA. However, the ineffective interval IEA is substantially short and is adjacent to the effective interval EA, so that it is possible for the position detection of the magnetic member 20 to affect the image display of the display substrate 100.

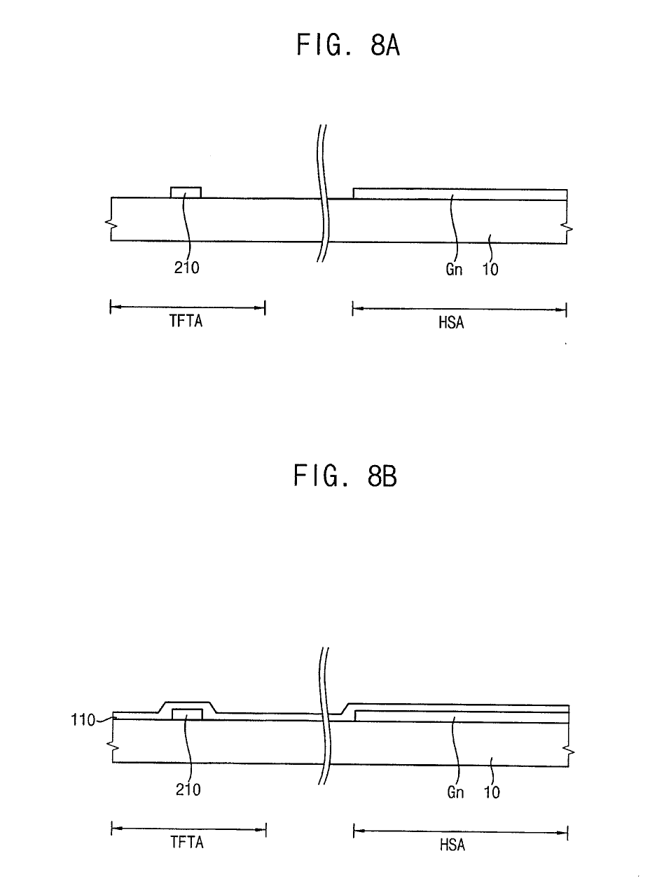

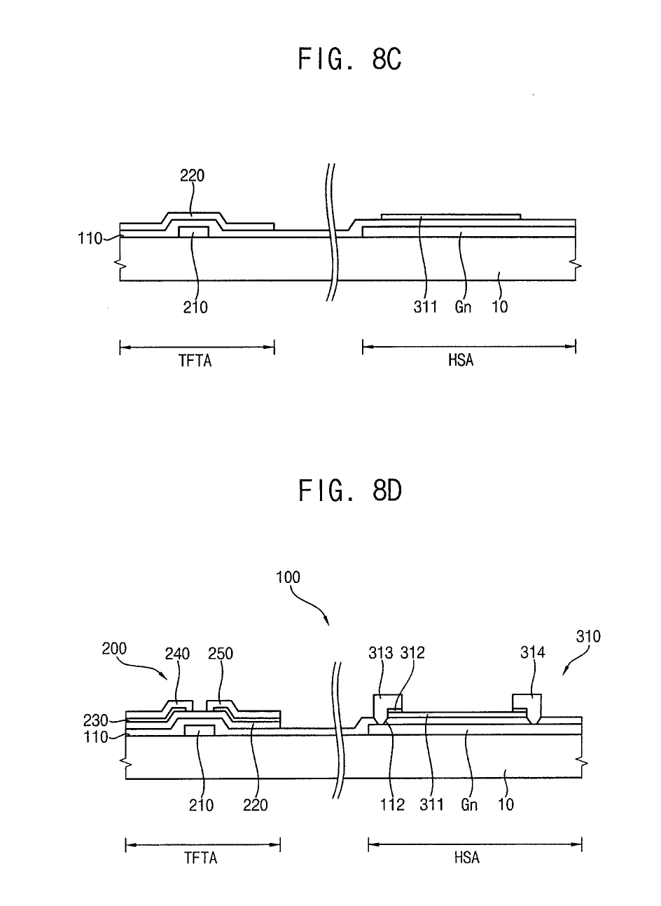

FIGS. 8A to 8D are cross-sectional views illustrating a manufacturing process of a display panel for a touch screen according to an exemplary embodiment of the present invention.

Referring to FIGS. 1, 2 and 8A, a plurality of gate lines G1 to Gn and a plurality of source lines S1 to Sm are formed on the insulation substrate 10 to manufacture the display substrate 100 of the display panel 1000, wherein ‘n’ and ‘m’ are natural numbers. In one exemplary embodiment, the gate lines G1 to Gn and the source lines S1 to Sm define a plurality of pixel parts P11 to Pnm on the insulating substrate 10; however, the pixel parts P11 to Pnm may also be otherwise defined. The gate lines G1 to Gn and the source lines S1 to Sm may be formed to cross at about 90 degrees. Then, the gate electrode 210 is formed in the TFT area TFTA formed in the pixel part Pnm. Substantially, the gate electrode 210 is electrically connected to the gate line Gn.

Referring to FIGS. 3 and 8B, a first insulation layer 110 is formed on the gate electrode 210, the gate line Gn and the source line Sm. For example, the first insulation layer 110 may fully cover the insulation substrate 10 having the gate electrode 210, the gate line Gn and the source line Sm formed thereon. The first insulating layer 110 may include silicon oxide (SiO2) having a superior adhesive force and protecting a formation of an air layer at an interface portion or a non-organic insulating material such as a silicon nitride (SiNx).

Referring to FIGS. 4 and 8C, the transistor silicon layer 220 is formed in the TFT area TFTA of the gate electrode 210, and simultaneously the first and second silicon layers 311 and 321 of the first and second sensors 310 and 320, respectively, are formed in the sensing part area HSA of the gate and source lines Gn and Sm. Here, the second silicon layer 321 is substantially the same as the first silicon layer 311 except that the second silicon layer 321 is disposed in the source line Sm. Thus, the first silicon layer 311 as a representation will be described.

Referring to FIGS. 4, 5 and 8D, the first, second, third and fourth electrodes 313, 314, 315 and 316 are formed on the transistor silicon layer 220 when the source electrode 240 and the drain electrode 250 are formed. Here, the electrode contact hole 112, which electrically connects the first and second electrodes 313 and 314 to the gate electrode 210, is formed in the first insulation layer 110. Hereinafter, the first, second, third and fourth electrodes 313, 314, 315 and 316 are described in FIG. 4, and thus a detailed description thereof will be omitted.

Alternatively, an ohmic contact layer 230 may be formed between the transistor silicon layer 220 and the source and drain electrodes 240 and 250. Here, a first ohmic contact layer 312 may be formed between the first silicon layer 311 and the first, second, third and fourth electrodes 313, 314, 315 and 316. Moreover, the first and second electrodes 313 and 314 may be electrically connected to the gate line Gn.

Then, the second insulation layer 120 is formed on the source and drain electrodes 240 and 250 of the TFT area TFTA, and then the pixel electrode 130 is formed on the second insulation layer 120. Here, a pixel electrode contact hole 122 may be formed on the second insulation layer 120 in order to electrically connect the pixel electrode 130 to the drain electrode 250.

The TFT 200 is formed in the TFT area TFTA, and simultaneously the hall sensing part 300 is formed in the hall sensing part area HSA.

According to the touch screen panel and the method for manufacturing the touch screen panel, a TFT is formed in pixel parts, and simultaneously hall sensing parts are formed in the pixel parts to detect a position of a magnetic member, so that a conventional touch screen pad may be omitted. Therefore, manufacturing costs, thickness and the number of manufacturing processes may be reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A touch screen panel comprising:
a plurality of pixel parts being electrically connected to one of a plurality of gate lines and one of a plurality of source lines;
a plurality of hall sensing parts formed in the pixel parts, the hall sensing parts varying a reference current applied to the gate lines and the source lines by a magnetic member; and
a position detector electrically connected to the gate lines and the source lines, the position detector detecting a position of the magnetic member using the gate and source lines to which the varied reference current is applied.

2. The touch screen panel of claim 1, wherein each of the pixel parts includes a thin-film transistor (TFT) electrically connected to one of the gate lines and one of the source lines, and the hall sensing parts are formed at edges of the gate lines and the source lines that cross each other and not in the TFT areas.

3. The touch screen panel of claim 2, wherein the hall sensing parts and the TFT are formed from the same layer.

4. The touch screen panel of claim 1, wherein each of the hall sensing parts comprises:
a first hall sensor electrically connected to the gate lines; and
a second hall sensor electrically connected to the source lines.

5. The touch screen panel of claim 4, wherein each of the first hall sensors comprises:
a first silicon layer formed on the gate lines;
first and second electrodes formed in two end portions of the first silicon layer, which are substantially parallel with the gate lines, the first and second electrodes being electrically connected to the gate lines; and
third and fourth electrodes formed in two end portions of the first silicon layer, which are substantially perpendicular to the gate lines, the third and fourth electrodes being electrically connected to the first and second electrodes, respectively.

6. The touch screen panel of claim 5, wherein the third and fourth electrodes apply an additional current generated by the magnetic member to the gate lines through the first and second electrodes to vary the reference current.

7. The touch screen panel of claim 4, wherein the second hall sensor comprises:
a second silicon layer formed on the source lines;
fifth and sixth electrodes formed in two end portions of the second silicon layer, which are substantially parallel with the source lines, the fifth and sixth electrodes being electrically connected to the source lines; and
seventh and eighth electrodes formed in two end portions of the second silicon layer, which are substantially perpendicular to the gate lines, the seventh and eighth electrodes being electrically connected to the fifth and sixth electrodes, respectively.

8. The touch screen panel of claim 7, wherein the seventh and eighth electrodes apply an additional current that is generated by the magnetic member to the source lines through the fifth and sixth electrodes to vary the reference current.

9. The touch screen panel of claim 4, further comprising:
a gate driving section disposed at a first side of the insulation substrate, the gate driving section that applies a gate voltage from the first side to a second side facing the first side; and
a source driving section disposed at a third side substantially perpendicular to the first and second sides, the source driving section that applies a source voltage from the third side to a fourth side facing the third side.

10. The touch screen panel of claim 9, wherein the position detector is integrated into the source driving section.

11. The touch screen panel of claim 10, wherein the position detector is electrically connected to a first detecting line part that connects end portions of the gate lines in correspondence to the second side, and a second detector that connects end portions of the source lines in correspondence to the fourth side.

12. The touch screen panel of claim 1, wherein at least one of the hall sensing part is formed in ‘k’ number of the pixel parts, wherein k is a natural number.

13. The touch screen panel of claim 9, wherein the source driving section repeatedly applies a source start voltage and the source voltage to the source lines, and the reference current is synchronized to the source start voltage and supplied to the gate and source lines.

14. The touch screen panel of claim 13, further comprising:
a power supplying section electrically connected to the gate driving section and the source driving section to apply the gate voltage and the source voltage to the gate driving section and the source driving section,
wherein the reference current is applied from the gate driving section, the source driving section and the power supplying section.

15. The touch screen panel of claim 9, wherein the insulation substrate comprises a display part that has the gate and source lines formed thereon and a peripheral area to the display area, and the position detector is formed on the peripheral area.

16. A method for manufacturing a touch screen panel comprising:
forming a gate line and a source line on an insulation substrate, and a gate electrode on a thin-film transistor (TFT) area;
forming a first insulation layer on the gate electrode, the gate line and the source line;
forming a silicon layer on the TFT silicon area of the gate electrode, and a silicon layer on a hall sensing part area of the gate and source lines; and
forming a source electrode and a drain electrode on the TFT silicon layer, and a plurality of electrodes on the silicon layer.

17. The method of claim 16, wherein the number of the electrodes is at least four in correspondence to the gate line, and the number of the electrodes is at least four in correspondence to the source line.

18. The method of claim 17, wherein forming the electrode on the silicon layer comprises:
forming first and second electrodes substantially in parallel with the gate line on the silicon layer, which are electrically connected to the gate line; and
forming third and fourth electrodes substantially perpendicular to the gate line on the silicon layer, which are electrically connected to the first and second electrodes.

19. The method of claim 18, wherein forming the electrode on the silicon layer comprises:
forming fifth and sixth electrodes substantially in parallel with the source line on the silicon layer, which are electrically connected to the source line; and
forming seventh and eighth electrodes substantially perpendicular to the source line on the silicon layer, which are electrically connected to the fifth and sixth electrodes.

20. The method of claim 16, further comprising:
forming a second insulation layer on the source electrode, the drain electrode and the electrodes; and
forming a pixel electrode electrically connected to the drain electrode on the second insulation layer.
